(19) United States
(12) Patent Application Publication
(10) Pub. No.: US 2007/0223564 A1
(43) Pub. Date: Sep. 27, 2007

(54) Csalable Video Coding Broadcasting

(75) Inventors: Wilhelmus Hendrikus Alfonsus Bruls, Eindhoven (NL); Yongqin Zeng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,722

(22) PCT Filed: May 4, 2005
(86) PCT No.: PCT/IB05/51464

§ 371 Date: Nov. 6, 2006

(30) Foreign Application Priority Data
May 12, 2004 (EP) 04102061.1

(51) Int. Cl. H04B 1/00

(52) U.S. Cl. 375/131

(57) ABSTRACT

A method of processing an input signal (SG0) is described. The method involves receiving the input signal (SG0). Moreover, the method also involves processing the input signal (SG0) into a base stream (SG1) and one or more enhanced streams (SG2, SG3) wherein the base stream (SG1) includes basic signal information and the one more enhanced streams (SG2, SG3) include enhancement signal information complementary to the basic signal information. Furthermore, the method involves combining the plurality of streams (SG1, SG2, SG3) to generate a corresponding composite signal (40) of constant bit rate (CBR), the composite signal (40) being susceptible to broadcasting in one multiplex.

The present invention relates to methods of processing signals; in particular, but not exclusively, the invention concerns a method of processing an input signal in a manner suitable for digital terrestrial broadcast. Moreover, the invention also relates to apparatus for generating signals suitable for use in such methods.

Systems for transmitting and receiving terrestrial broadcasts are known. More recently, for example with regard to digital television and radio, digital terrestrial broadcast is becoming increasingly used and has resulted in establishment of recognized international standards. For example, in a known Digital Video Broadcasting-Terrestrial (DVB-T) standard, there is defined a method of transmitting MPEG-2 encoded television signals. The DVB-T standard is adapted to specific features of an associated terrestrial channel used for transmission, the channel being potentially subject to multipath propagation and hence to degraded transmission reception. Other alternative digital terrestrial broadcast standards are known, for example ATSC.

Variants of DVB-T have been recently proposed. For example, in an article “Hierarchical Modulation” by Weck and Schertz published in April 2003 in EBU Technical Review, a variant of DVB-T is described. This variant enables the transmission of two independent DVB-T multiplexes onto a single television channel. The transmission has two multiplexed components, namely a high priority (HP) multiplex component and a low priority (LP) multiplex component. The high priority multiplex component is especially suitable for domestic indoor reception and mobile reception, for example in connection with using palm-held miniature televisions, where screen resolution is limited and where preservation of fine image detail is not expected by users.

It is known from the publication that multiplexed components of hierarchical modulation vary in their susceptibility to noise. Consequently, service coverage areas potentially differ in size for each of the multiplex components. The high priority (HP) multiplex component provided with a lower data rate is susceptible to being used to address a relatively larger coverage area, whereas the low priority (LP) multiplex component is more restricted in coverage area. In the publication, it is known that the coverage area of the HP multiplex component is influenced by its modulation parameter α which can be varied at the expense of robustness of the LP multiplex component.

Therefore, in the aforementioned DVB-T standard, two separate data multiplex components are modulated into one signal, namely the HP data component is embedded into the LP component. Moreover, the LP multiplex component is often referred to as a main channel. Conventionally, the HP multiplex component has a relatively low data-carrying capacity in the order of 4.5 Mbytes/second, whereas the LP multiplex component has a higher capacity of substantially 13.5 Mbytes/second. However, reception of the LP multiplex component is less reliable than the HP stream, especially under compromised multipath reception conditions. In view of such reception characteristics, the LP multiplex component is often used to transmit a low resolution version of video program content, for example one or more video signals, at a relatively low bit-rate. The HP multiplex component is then used to transmit a full resolution version of the program content at a regular bit-rate, for example for high-quality high definition (HD) television purposes.

In a situation of poor reception, the LP multiplex component is normally unusable when received; however, the HP component remains useable and is susceptible to being used to generate a reasonably acceptable video signal when demodulated. When reception of the LP component improves, the LP component can then be used to generate corresponding high quality video signals again.

The inventor has appreciated that such an allocation of data streams in DVB-T transmission is not optimal and has therefore devised an improved broadcasting method.

The inventor has appreciated that an alternative manner to implement the DVB-T standard is to arrange it as a hierarchical compression scheme including two or more data layers, for example a low resolution base layer for inclusion in the HP multiplex component and a full resolution enhancement layer for the LP multiplex component. Such an implementation is more efficient because it avoids duplication of information in HP and LP multiplex components as encountered in known digital broadcast approaches, for example as described in the foregoing. Since both HP and LP multiplex components conventionally have fixed data rates, this implementation will result in fixed data rates for conveying the two layers.

In devising the present invention, the inventor has identified that it is beneficial to employ variable bit rate. Moreover, in the context of the present invention in general, if N video streams are allowed, the inventor has envisaged that statistical multiplexing is conveniently employed wherein the sum of the bit-rates of the N streams has to be substantially constant but can be varied in proportion between the N channels, for example dynamically depending on instantaneous program content. Furthermore, the inventor has appreciated that application of statistical multiplexing functions better as the number of streams N is increased. On account of the nature of contemporary hierarchical modulation schemes, statistical multiplexing is not presently possible over fixed borders distinguishing LP and HP multiplex components and hence has hitherto not been employed.

Thus, an object of the present invention is to provide an improved method of processing a signal which reduces information duplication which arises, for example, in contemporary digital terrestrial broadcasting systems.

According to a first aspect of the present invention, there is provided a method of processing an input signal (SG0), the method involving steps of:

a) receiving the input signal (SG0);

b) processing the input signal (SG0) into a base stream (S₁) and one or more enhanced streams (S₂) wherein the base stream (S₁) includes basic signal information and the one or more enhanced streams (S₂) include enhancement signal information complementary to the basic signal information; and

c) combining the plurality of streams (S₁, S₂) to generate a corresponding composite signal of constant bit rate (CBR).

The invention is of advantage in that the base stream (S₁) is potentially susceptible to being received when one or more of the enhanced streams (S₂) are adversely affected by interference, such a base stream (S₁) thereby enabling the input signal (SG0) to be appreciated at least at a basic level.

Preferably, in the method, the base stream (S₁) comprises a first part having constant bit rate (CBR) properties and a second part having variable bit rate (VBR) properties. Such a partitioning into constant bit rate (CBR) and variable bit rate (VBR) allows for dynamic partitioning in the composite signal and hence potentially more optimal use of bandwidth.

Preferably, the method includes a step of combining the base stream (S₁) and the one or more enhanced streams (S₂) to generate the composite signal by using system multiplexing. Applying multiplexing is of advantage in generating relatively fewer output streams in the composite signal.

Preferably, the method includes a step of arranging for the second part of the base stream (S₁) when combined with the one or more enhanced streams (S₂) to generate a corresponding signal of constant bit rate (CBR) for inclusion in the composite signal. Constant bit rate (CBR) in the composite signal is of benefit in ensuring that the composite signal is maintained within an allocated bandwidth when communicated, for example broadcast by way of terrestrial wireless transmission.

Preferably, in the method, the composite signal is communicated using a hierarchical modulation scheme comprising a relatively more robust high priority (HP) channel and a relatively less robust low priority (LP) channel, the first part of the base stream (S₁) having constant bit rate (CBR) properties being conveyed in the high priority (HP) channel and the second part of the base stream (S₁) having variable bit rate (VBR) properties together with the one or more enhanced streams (S₂) being conveyed in the low priority (LP) channel. Dynamic partitioning is of benefit in that information carrying capacity of the composite signal is more efficiently utilized. More preferably, the method includes a step of grading the input signal (SG0) into the plurality of streams wherein partitioning between the streams is dynamically changeable depending on content present in the input signal (SG0).

Preferably, in the method, splitting of the base stream (S₁) into its associated first and second parts is performed using bit rate translation (BRT). BRT is a technique involving applying attenuation to coefficients associated with the base stream (S₁), wherein resulting attenuated coefficients are used to produce the first part of the base stream, and differences between incoming unattenuated coefficients and the attenuated coefficients are used to produce the second part of the base stream. Moreover, BRT is described in a European patent application no. 01 401 029.1 which is hereby incorporated by reference.

Preferably, in the method, splitting of the base stream (S₁) into its associated first and second parts is performed using MPEG data partitioning. Such MPEG data partitioning is known from an international standard ISO/IEC 13818-2 which is hereby incorporated by reference.

Preferably, in the method, splitting of the base stream (S₁) into its associated first and second parts is performed using MPEG SNR scalability. MPEG is a known contemporary international standard. Moreover, SNR scalability allows enhancement information to be conveyed by a second data stream intended to enhance corresponding coefficients of a first data stream. Moreover, SNR scaling is an ISO standard described in the aforementioned standard ISO/IEC 13818-2.

Preferably, the method includes a step of structuring the composite signal so that the base stream (S₁) is robustly included within a relatively smaller bandwidth of the composite signal which is less prone to interference, and the one or more enhanced streams (S₂) are included within a relatively wider bandwidth of the composite signal which is more prone to interference.

Preferably, in the method, bit rate control of the one or more enhanced streams (S₂) is made dependent upon bit rates being used for the base stream (S₁).

Preferably, the method is used for at least one of terrestrial wireless broadcast, satellite wireless broadcast, wireless transmission and cable network broadcast.

According to a second aspect of the present invention, there is provided an apparatus for processing an input signal (SG0), the apparatus including:

a) a data processor for receiving the input signal (SG0) and for processing the input signal (SG0) into a base stream (S₁) and one or more enhanced streams (S₂) wherein the base stream (S₁) includes basic signal information and the one or more enhanced streams (S₂) include enhancement signal information complementary to the basic signal information; and

b) a signal combiner for combining the streams (S₁, S₂) to generate a corresponding composite signal of constant bit rate (CBR).

Preferably, in the apparatus, the processor is operable to split the input signal (SG0) into the base stream (S₁) comprising a first part having constant bit rate (CBR) properties and a second part having variable bit rate (VBR) properties for use in generating the composite signal.

Preferably, the apparatus, the signal combiner is operable to combine the base stream (S₁) and the one or more enhanced streams (S₂) to generate the composite signal by system multiplexing.

It will be appreciated that features of the invention are susceptible to being combined in any combination without departing from the scope of the invention.

Embodiments of the invention will now be described, by way of example only, with reference to the following diagrams wherein:

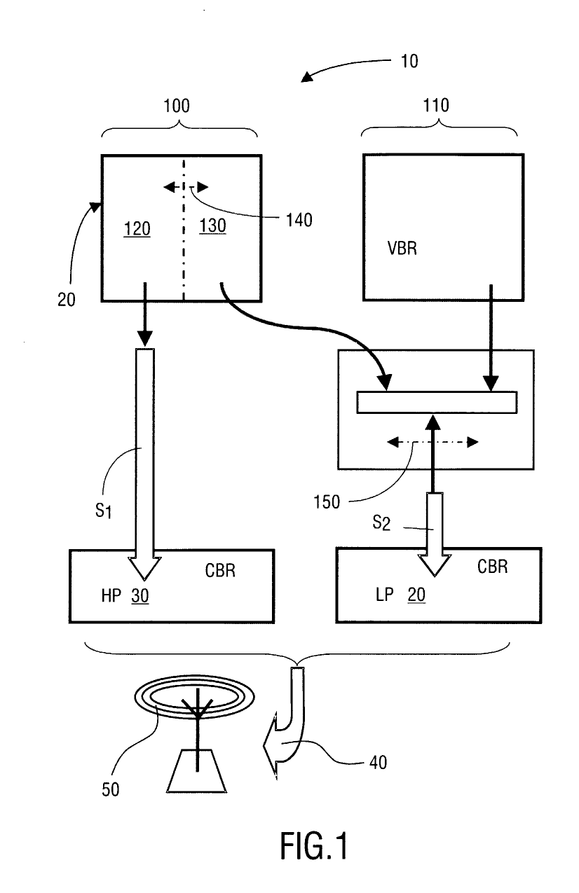

FIG. 1 is a schematic illustration of dynamic data partitioning for processing a video data to generate corresponding high priority (HP) and low priority (LP) multiplex components;

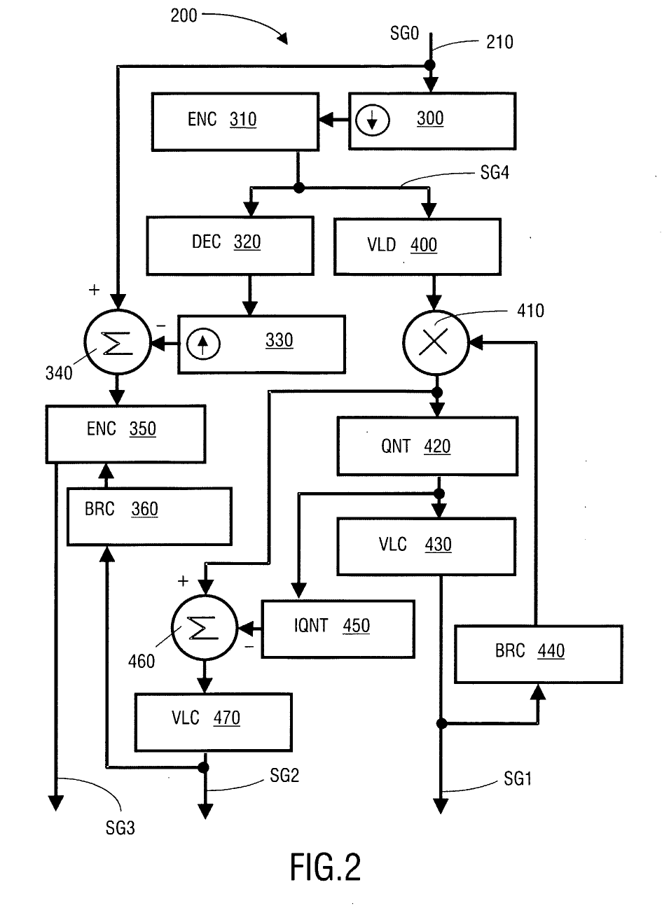

FIG. 2 is a schematic diagram of apparatus operable to process an input video stream to generate statistically multiplexed LP and HP streams; and

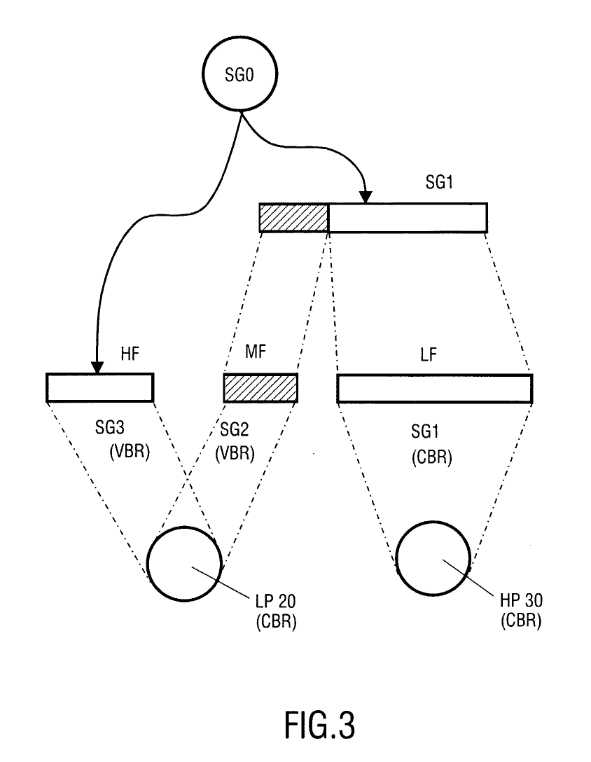

FIG. 3 is a diagram illustrating video information allocation with the apparatus of FIG. 2.

In overview, the inventors have devised a broadcasting method as depicted schematically in FIG. 1; principal steps of the method are indicated generally by 10. The method 10 involves including at least a low priority (LP) multiplex component 20 and a high priority (HP) multiplex component 30 which are combinable to generate a composite signal 40 suitable for terrestrial broadcast 50, for example as wireless transmission and/or via optical fiber communication networks. Moreover, the LP 20 and HP 30 multiplex components are structured so as to allow for variable bit-rate transmission, thereby allowing for statistical multiplexing to be utilized over borders defining the LP component 20 relative to the HP component 30. Compression techniques are also susceptible to being utilized in conjunction with such statistical multiplexing. By applying the method 10 of the invention, variable bit-rate (VBR) data can be converted into a first data stream S₁ arranged to have a constant bit-rate (CBR) for conveying spatially low frequency and spatially medium frequency image information, and a second data stream S₂ arranged to accommodate variable bit-rate (VBR) data for conveying less important spatially high frequency image information. The two data streams S₁, S₂ are susceptible to being conveyed in the aforementioned LP and HP multiplex components 20, 30 as elucidated earlier.

For example, when video program content is conveyed by a dual layer scheme comprising a base layer 100 and an enhancement layer 110, it is beneficial that:

a) a first part 120 of the base layer 100 is allocated at constant bit rate (CBR) to the HP multiplex component 30; and

b) the enhancement layer 110 is arranged in such a manner that it is susceptible to being combined with a second part 130 of the base layer 100 which is CBR for transmission in the LP multiplex component 20.

Partitioning of the base layer 100 in the first and second parts 120, 130 respectively is optionally dynamically variable as denoted by an arrow 140. Additionally, or alternatively, a proportion of data included from the enhancement layer 110 and the second part 130 in the LP stream LP 20 is optionally dynamically variable as denoted by an arrow 150. For example, a degree of fine detail included in the signal 40 from the enhancement layer 110 is dynamically altered so as to maintain CBR in the stream S₂.

Implementation of the method 10 illustrated in FIG. 1 will now be described with reference to FIG. 2. In FIG. 2, there is shown an apparatus indicated generally by 200, the apparatus 200 being implemented in one or more of hardware and software. In overview, the apparatus 200 is operable to receive an input video stream SG0 at an input 210 and to output corresponding output streams SG1, SG2, SG3 wherein the stream SG3 constitutes the HP stream of constant bit rate (CBR) and a combination of the variable bit rate (VBR) streams SG2, SG3 constitutes the LP stream.

Component parts of the apparatus 200 will now be described followed by a description of its operation.

The apparatus 200 comprises the input 210 coupled via a spatial scale down function 300 in series with an encoder (ENC) 310 to provide an intermediate encoded output stream SG4. The intermediate stream SG4 is coupled to a decoder (DEC) 320 and then via a spatial scale up function 330 to provide a subtraction data signal at a subtraction input (−) of an arithmetic function 340. An addition input (+) of the arithmetic function 340 is coupled to receive the input video stream (SG0). A difference output of the arithmetic function 340 is coupled via a variable encoder (ENC) 350 whose output constitutes the output stream SG3. The variable encoder 350 is arranged so that its output bit rate is controllable from a bit rate control function (BRC) 360 whose input is coupled to the output stream SG2.

The intermediate stream SG4 is also coupled via a video formatting function (VLD) 400 to a first input of a multiplying function 410 and also to an addition input (+) of an arithmetic function 460. An output of the multiplying function 410 is connected to a quantizing function (QNT) 420 whose corresponding quantized output is coupled via a variable length coding function (VLC) 430 to the data stream SG1. Moreover, the quantized output of the coding function 430 is also coupled via an inverse quantizing function 450 to a subtraction input of the arithmetic function 460. An output of the arithmetic function 460 is connected via a variable length coding (VLC) function 470 to generate the output stream SG2. Moreover, the output stream SG1 is coupled via a bit rate control (BRC) function 440 to a second input of the multiplying function 410.

In operation, the scale down function 300, the encoder 310, the decoder 320 and scale up function 330 in combination with the arithmetic function 340 to generate an error output signal from the arithmetic function 340 substantially corresponding to an error arising in the encoder 310 functioning in combination with the decoder 320. This error signal is encoded in the encoder 350 to generate the stream SG3, the encoder 350 being dynamically adjustable with regard to the resolution of spatial components of the error signal to be encoded into the stream SG3 in response to a control signal received from the bit rate controller 360. Thus, the bit rate control function 360 is operable to monitor the bit rate of the stream SG2 and control in a slave manner the encoder 350 so that a combination of the streams SG2, SG3 results in constant bit rate (CBR) data stream whereas the streams SG2, SG3 can each individually be variable bit rate (VBR). The controller 360 corresponds to the action of the arrow 150 shown in FIG. 1. Moreover, the output of the arithmetic function 340 corresponds to enhancement layer 110 in FIG. 1. Moreover, the stream SG2 corresponds to the second part 130 in FIG. 1.

The bit rate controller 440 in combination with the multiplying function 410 and the quantizing function 420 together with the coding function 430 form a feedback loop operable to maintain a constant bit rate (CBR) in the stream SG1 Video information lost at the quantizing function 420 is recovered at the output of the arithmetic function 460 and used to generate the stream SG2. Thus, the feedback loop including the controller 440, the multiplying function 410 and the quantizing function are operable to control dynamically partitioning between the first and second parts 120, 130 respectively as denoted by the arrow 140 in FIG. 1.

Hence, a low spatial frequency (LF) representation of images input to the apparatus 200 in the video input stream SG0 is provided in the SG1 stream, whereas corresponding medium spatial frequency (MF) representations are provided at the stream SG2. A proportion of high spatial frequency (HF) representations provided at the SG3 output is varied in a slave manner to the amount of medium spatial frequency (MF) information being handled at any particular instance of time by the apparatus 200. Moreover, a considerable amount of low spatial frequency (LF) information presented at the SG1 stream will also potential affect an amount of high spatial frequency (HF) information which is possible to include in the SG3 stream. Such dynamic partitioning is also illustrated in FIG. 3 to supplement FIG. 2. Subsequently, in the apparatus 200, the HP and LP streams 30, 20 respectively are combined to generate the aforementioned composite signal 40 for transmission wherein the HP stream 30 is rendered robust in the composite signal 40 by virtue of it occupying a smaller bandwidth relative to the LP stream 20 and as a consequence of modulation format employed in the component signal 40.

Although three streams SG1, SG2, SG3 corresponding to information pertaining to progressively finer spatial resolution are described in the foregoing, it will be appreciated that more than three streams can potentially be catered for and combined to generate a corresponding composite signal for transmission, wherein lower spatial frequency image components are included in most robust parts of the transmission. Beneficially, partitioning of video data distribution between the streams is rendered dynamically variable in order to maintain a substantially constant bit rate for transmission to try to fully populate with energy allocated transmission bandwidth.

On account of the use of variable bit rate in the apparatus 200 for encoding the base layer 100, image quality conveyed in the composite signal is thereby enhanced at critical moments, for example where considerable complex motion is occurring within a video scene. Moreover, the present invention can also be used to pack more video channels into a given available transmission bandwidth in the broadcast 50 while maintaining video image quality.

Moreover, the present invention also substantially avoids duplication of image information between high priority HP and low priority LP streams, namely circumvents a problem with contemporary video broadcast systems where information duplication can occur resulting in non-optimal utilization of allocated broadcast bandwidth.

In conditions of poor reception of the transmission 50, the HP stream included robustly in the transmission 50 and derived from the stream SG1 of the apparatus 200, allows coarser image quality during poor reception thereby providing users of corresponding receiving apparatus to receive more reliably at least a coarser representation of the video stream SG0. In general, portable receivers such as palm-held televisions include relatively small antennae of low gain and therefore inherently suffer more from spontaneous noise arising in their radio frequency preamplifiers. Moreover, such palm-held televisions are more susceptible to receiving sporadic local noise and interference in comparison to more permanent television receiver installations relying on higher-gain roof-top antennae for receiving terrestrial broadcasts.

If required, the transmission 50 can be provided with more than two graded priority levels; for example it can be adapted to include a high priority stream (HIP), a higher medium priority stream (HMP), a lower medium priority stream (LMP) and a lower priority stream (HP), there then being four priority streams included within the transmission 50. Partitioning of data between these numerous streams is preferably dynamically variable depending on program content as described in the foregoing. Moreover, if required, the number of streams in use can be made dynamically variable in response to program content present in the signal SG0.

In the accompanying claims, numerals and other symbols included within brackets are included to assist understanding of the claims and are not intended to limit the scope of the claims an any way.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of processing an input signal (SG0), the method involving steps of:
a) receiving the input signal (SG0);
b) processing the input signal (SG0) into a base stream (S₁) and one or more enhanced streams (S₂) wherein the base stream (S₁) includes basic signal information and the one or more enhanced streams (S₂) include enhancement signal information complementary to the basic signal information; and
c) combining the plurality of streams (S₁, S₂) to generate a corresponding composite signal (40) of constant bit rate (CBR).

2. A method according to claim 1, wherein the base stream (S₁) comprises a first part having constant bit rate (CBR) properties and a second part having variable bit rate (VBR) properties.

3. A method according to claim 2, including a step of combining the base stream (S₁) and the one or more enhanced streams (S₂) to generate the composite signal (40) by using system multiplexing.

4. A method according to claim 3, including a step of arranging for the second part of the base stream (S₁) when combined with the one or more enhanced streams (S₂) to generate a corresponding signal of constant bit rate (CBR) for inclusion in the composite signal (40).

5. A method according to claim 4, wherein the composite signal (40) is communicated using a hierarchical modulation scheme comprising a relatively more robust high priority (HP) channel and a relatively less robust low priority (LP) channel, the first part of the base stream (S₁) having constant bit rate (CBR) properties being conveyed in the high priority (HP) channel and the second part of the base stream (S₁) having variable bit rate (VBR) properties together with the one or more enhanced streams (S₂) being conveyed in the low priority (LP) channel.

6. A method according to claim 1, including a step of grading the input signal (SG0) into the plurality of streams wherein partitioning between the streams is dynamically changeable depending on content present in the input signal (SG0).

7. A method according to claim 2, wherein splitting of the base stream (S₁) into its associated first and second parts is performed using bit rate translation (BRT).

8. A method according to claim 2, wherein splitting of the base stream (S₁) into its associated first and second parts is performed using MPEG data partitioning.

9. A method according to claim 2, wherein splitting of the base stream (S₁) into its associated first and second parts is performed using MPEG SNR scalability.

10. A method according to claim 1, including a step of structuring the composite signal (40) so that the base stream (S₁) is robustly included within a relatively smaller bandwidth of the composite signal (40) which is less prone to interference, and the one or more enhanced streams (S₂) are included within a relatively wider bandwidth of the composite signal (40) which is more prone to interference.

11. A method according to claim 2, wherein bit rate control of the one or more enhanced stream (S₂) is made dependent upon bit rates being used for the base stream (S₁).

12. A method according to claim 1, used for at least one of terrestrial wireless broadcast, satellite wireless broadcast, wireless transmission and cable network broadcast.

13. An apparatus for processing an input signal (SG0), the apparatus including:
a) a data processor for receiving the input signal (SG0) and for processing the input signal (SG0) into a base stream (S₁) and one or more enhanced streams (S₂) wherein the base stream (S₁) includes basic signal information and the one or more enhanced streams (S₂) include enhancement signal information complementary to the basic signal information; and
b) a signal combiner for combining the streams (S₁, S₂) to generate a corresponding composite signal (40) of constant bit rate (CBR).

14. An apparatus according to claim 13, wherein the processor is operable to split the input signal (SG0) into the base stream (S₁) comprising a first part having constant bit rate (CBR) properties and a second part having variable bit rate (VBR) properties for use in generating the composite signal (40).

15. An apparatus according to claim 13, wherein the signal combiner is operable to combine the base stream (S₁) and the one or more enhanced streams (S₂) to generate the composite signal (40) by system multiplexing.
